(19) United States
(12) Patent Application Publication
(10) Pub. No.: US 2026/0223090 A1
(43) Pub. Date: Jul. 30, 2026

(54) METHOD PERFORMED BY NODE IN WIRELESS COMMUNICATION SYSTEM AND WIRELESS COMMUNICATION DEVICES

(71) Applicant: SAMSUNG ELECTRONICS CO., LTD., Suwon-si, Gyeonggi-do (KR)

(72) Inventors: Di SU, Beijing (CN); Chen QIAN, Beijing (CN); Peng LIN, Beijing (CN)

(21) Appl. No.: 19/140,990

(22) PCT Filed: Dec. 19, 2023
(86) PCT No.: PCT/KR2023/020982

§ 371 Date: Jun. 18, 2025

(30) Foreign Application Priority Data
Dec. 20, 2022 (CN) 202211643686.7

(51) Int. Cl. H04W 72/0453; H04L 1/18; H04L 5/00; H04L 27/26; H04W 72/0446

(52) U.S. Cl. CPC H04W 72/0453; H04L 1/18; H04L 5/0051; H04L 27/2607; H04W 72/0446

(57) ABSTRACT

The disclosure relates to a 5G or 6G communication system for supporting a higher data transmission rate. The present disclosure relates to methods performed respectively by a first node and a second node in a wireless communication system and wireless communication devices. A method of a first node in a wireless communication system comprises: generating first physical layer data, wherein the first physical layer data includes first physical layer data unit with a first number of repetitions; generating, based on the first physical layer data, second physical layer data, wherein the second physical layer data includes the first physical layer data with a second number of repetitions; and transmitting the second physical layer data.

### TECHNICAL FIELD

The present application relates to wireless communication, and more particularly, to physical layer data transmission.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The present disclosure relates to wireless communication systems and, more specifically, the invention relates to method performed by node in wireless communication system.

### Solution to Problem

Embodiments of the present disclosure provide methods performed by a first node and a second node, respectively, in a wireless communication system and communication devices.

According to an aspect of the embodiments of the present disclosure, a method of a first node in a wireless communication system comprises: generating first physical layer data, wherein the first physical layer data includes first physical layer data unit with a first number of repetitions; generating, based on the first physical layer data, second physical layer data, wherein the second physical layer data includes the first physical layer data for a second number of repetitions; transmitting the second physical layer data.

In one embodiment, generating the first physical layer data comprises: generating at least one first physical layer data unit based on a physical signal or channel; and generating, for each of all or part of the at least one first physical layer data unit, a first repetition physical layer data unit being on the first number of time-domain units, and wherein each first repetition physical layer data unit includes a cyclic prefix and the first physical layer data unit with the first number of repetitions.

In one embodiment, the length of the cyclic prefix is a sum of lengths of respective cyclic prefixes of the first number of time-domain units.

In one embodiment, the first number of time-domain units are the first number of continuous time-domain units.

In one embodiment, generating the first physical layer data comprises: generating at least one data symbol based on a physical signal or channel; for each of the at least one data symbol: mapping the data symbol onto subcarrier with predetermined subcarrier index(es) to obtain a frequency-domain signal; generating, based on the frequency-domain signal, a first repetition physical layer data unit being on one time-domain unit, wherein the first repetition physical layer data unit includes a cyclic prefix and the first physical layer data unit with the first number of repetitions.

In one embodiment, mapping the data symbol onto the subcarriers with the predetermined subcarrier indexes comprises: mapping the data symbol onto the subcarriers with even indexes at a subcarrier mapping spacing, wherein the subcarrier mapping spacing corresponds to the first number.

In one embodiment, subcarriers with odd indexes within the time-domain unit corresponding to each of the at least one data symbol are unavailable subcarriers.

In one embodiment, the subcarrier mapping spacing has a configurable value, or the subcarrier mapping spacing has a fixed value, or the subcarrier mapping spacing has a value of 2.

In one embodiment, the subcarrier mapping spacing is configured by at least one of a higher layer signaling, downlink control information, or media access control (MAC) control information.

In one embodiment, the subcarrier mapping spacing is configured for specific physical layer data, or for specific one or more transmissions of specific physical layer data, or for specific physical resources.

In one embodiment, the subcarrier mapping spacing is configured by configuring a configured subcarrier spacing for transmission of the physical channel or signal.

In one embodiment, the length of the cyclic prefix is a length of a cyclic prefix corresponding to the configured subcarrier spacing.

In one embodiment, the first number is an even number, or the first number is a power of 2.

In one embodiment, at least one of the first number, the second number and a total number is a configurable parameter, wherein the total number is a product of the first number and the second number.

In one embodiment, the physical channel or signal comprises at least one of a physical uplink shared channel (PUSCH), a sounding reference signal (SRS) or a demodulation reference signal (DMRS).

In one embodiment, the second number is a value greater than or equal to 1.

In one embodiment, the number of first physical layer data units among the at least one first physical layer data unit that are associated with the first number of continuous time-domain units is determined based at least in part on the number of continuously allocated time-domain units allocated to the physical channel or signal and the first number.

In one embodiment, when the first physical layer data occupies a plurality of slots, the first physical layer data occupies time-domain units at the same position in the plurality of slots.

In one embodiment, when the physical channel or signal is a physical uplink shared channel (PUSCH), the method further comprises: determining position of time-domain unit of a demodulation reference signal (DMRS) based on at least one of indication of repetition type of the PUSCH, indication of time-domain position offset of the DMRS, or indication of time-domain position of the DMRS.

In one embodiment, determining the position of time-domain unit of the DMRS comprises: obtaining the indication of time-domain position offset of the DMRS, determining the position of time unit of the DMRS based on the obtained indication of time-domain position offset of the DMRS, wherein the indication of time-domain position offset of the DMRS is obtained by at least one of a higher layer signaling, downlink control information, and MAC control information.

In one embodiment, the indication of time-domain position offset of the DMRS is used for indicating an index value of at least one of the time-domain units to which the DMRS is mapped to be increased or decreased by N, where N is a positive integer, and N is a configured value, or is a fixed value in protocol.

In one embodiment, the method further comprises determining indication message for indicating time-domain position of the DMRS according to the indication of repetition type of the PUSCH.

In one embodiment, when the repetition type of the PUSCH is two-level repetition, the number of the indication message for indicating time-domain position of the DMRS is greater than the number of the indication message for indicating time-domain position of the DMRS when the repetition type of the PUSCH is not the two-level repetition.

In one embodiment, when the repetition type of the PUSCH is the two-level repetition, the length of the indication message for indicating time-domain position of the DMRS is greater than the length of indication message for indicating time-domain position of the DMRS when the repetition type of the PUSCH is not the two-level repetition.

In one embodiment, when the physical channel or signal is a physical uplink shared channel, the method further comprises determining whether to adjust a position of at least one of the time-domain units to which the DRMS is mapped in a preset way based at least in part on a relative position relationship between a set of time-domain units allocated to the physical channel or signal and the time-domain units to which the DMRS is mapped.

In one embodiment, at least one of the time-domain units to which the DMRS is mapped is the time-domain units other than the first time-domain unit among the time-domain units to which the DMRS is mapped.

In one embodiment, adjusting the position of at least one of the time-domain units to which the DMRS is mapped in the preset way comprises increasing or decreasing the index value of the at least one time-domain unit by a preset offset value.

According to another aspect of the embodiments of the present disclosure, a method performed by a second node in a wireless communication system comprises: transmitting configuration information for resources of second physical layer data; receiving, based on the resources of the physical layer data, the second physical layer data; wherein the second physical layer data includes first physical layer data for a second number of repetitions, and the first physical layer data includes first physical layer data unit with a first number of repetitions.

According to another aspect of the embodiments of the present disclosure, a method performed by a first node in a wireless communication system comprises: receiving configuration information for resources of second physical layer data; receiving, based on the resources of the physical layer data, the second physical layer data, wherein the second physical layer data includes first physical layer data for a second number of repetitions, and the first physical layer data includes first physical layer data unit with a first number of repetitions.

According to another aspect of the embodiments of the present disclosure, a method performed by a second node in a wireless communication system comprises: transmitting configuration information for resources of second physical layer data; transmitting, based on the resources of the physical layer data, the second physical layer data, wherein the second physical layer data includes first physical layer data with a second number of repetitions, and the first physical layer data includes first physical layer data unit with a first number of repetitions.

According to another aspect of the embodiments of the present disclosure, a wireless communication device comprises: a transceiver; and a controller coupled with the transceiver and configured to perform a method performed by a first node in a wireless communication system according to the embodiments of the present disclosure.

According to another aspect of the embodiments of the present disclosure, a wireless communication device comprises: a transceiver; and a controller coupled with the transceiver and configured to perform a method performed by a second node in a wireless communication system according to the embodiments of the present disclosure. The foregoing summary is merely illustrative and is not intended to be limiting in any way. In addition to the above illustrative aspects, embodiments and features, other aspects, embodiments and features will become apparent by referring to the accompanying drawings and the following detailed description.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

FIG. 1 illustrates an example wireless network according to various embodiments of the present disclosure;

FIGS. 2a and 2b illustrate example wireless transmission and reception paths according to the present disclosure;

FIG. 3a illustrates an example user equipment according to the present disclosure;

FIG. 3b illustrates an example base station according to the present disclosure;

FIG. 4 illustrates an exemplary schematic diagram of first-level repetition of physical layer data according to an embodiment of the present disclosure;

FIG. 5 illustrates another exemplary schematic diagram of first-level repetition of physical layer data according to an embodiment of the present disclosure;

FIG. 6 illustrates an exemplary schematic diagram of a method for two-level repetition according to an embodiment of the present disclosure;

FIG. 7 illustrates another exemplary schematic diagram of a method for two-level repetition according to an embodiment of the present disclosure;

FIG. 8 illustrates an exemplary flowchart of a communication method performed by a first node in a wireless communication system according to an embodiment of the present disclosure;

FIG. 9 illustrates an exemplary flowchart of a communication method performed by a second node in a wireless communication system according to an embodiment of the present disclosure;

FIG. 10 illustrates an exemplary flowchart of a communication method performed by a first node in a wireless communication system according to an embodiment of the present disclosure;

FIG. 11 illustrates an exemplary flowchart of a communication method performed by a second node in a wireless communication system according to an embodiment of the present disclosure;

FIG. 12 illustrates an exemplary block diagram of a wireless communication device according to an embodiment of the present disclosure;

FIG. 13 illustrates an exemplary block diagram of another wireless communication device according to an embodiment of the present disclosure.

### MODE FOR THE INVENTION

In order to make the purpose, technical solution and advantages of the embodiments of the present disclosure more clear, the technical solution of the embodiments of the present disclosure will be described clearly and completely in conjunction with the accompanying drawings of the embodiments of the present disclosure. Obviously, the described embodiments are part of the embodiments of the present disclosure, not all the embodiments. Based on the described embodiments of the present disclosure, all the other embodiments obtained by ordinary skilled in the art without requiring creative labor, belong to the scope of protection of the present disclosure. Text and drawings are provided as examples only to help the readers understand the present disclosure. They are not intended to and should not be construed to limit the scope of the present disclosure in any way. Although certain embodiments and examples have been provided, based on the disclosure disclosed herein, it is obvious to those skilled in the art that changes can be made to the illustrated embodiments and examples without departing from the scope of the present disclosure. In addition, for the sake of clarity and conciseness, descriptions of well-known functions and structures may be omitted.

Before the following description of the specific embodiments, it may be advantageous to clarify the definitions of certain words and phrases used throughout this patent document. The terms used herein to describe the embodiments of the present disclosure is not intended to constrain and/or limit the scope of the present disclosure. For example, unless otherwise defined, the technical terms or scientific terms used in the present disclosure shall have their ordinary meanings as understood by ordinary skilled in the art to which the present disclosure belongs. Terms such as those defined in dictionaries, should be interpreted as having meanings consistent with those in their contexts in relevant technical fields, and should not be interpreted in an idealized or overformalized way, unless explicitly defined as such in the present disclosure.

It should be understood that singular forms of “a”, “an” and “the” include plural referents, unless otherwise indicated clearly in the context. Thus, for example, a reference to a “component surface” includes a reference to one or more such surfaces.

The term “including” or “having” can be interpreted as existence of certain characteristics, numerals, steps, operations, constituent elements, components or combinations thereof, but should not be interpreted as excluding a possibility of existence of one or more of other characteristics, numerals, steps, operations, constituent elements, components or combinations thereof.

The term “or” used in various embodiments of the present disclosure includes any of the listed terms and all combinations thereof. For example, “A or B” may include A, may include B, or may include both A and B.

It should be understood that “first”, “second” and similar words used in the present disclosure do not indicate any order, quantity or importance, but are merely used to distinguish between different constituent components.

As used herein, any reference to “one example”, “one embodiment” or “an embodiment” means that a particular element, feature, structure or characteristic described in conjunction with the embodiment is included in at least one embodiment. The phrases “in one embodiment” or “in one example” present in different places in the specification are not necessarily all referring to the same embodiment.

The technical solution of the embodiments of the present disclosure can be applied to various communication systems, such as Global System for Mobile Communications (GSM) system, Code Division Multiple Access (CDMA), CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunications System (UMTS), Worldwide interoperability for Microwave Access (WiMAX) communication system, 5th Generation (5G) system or New Radio (NR), etc. In addition, the technical solution of the embodiments of the present disclosure can be applied to future-oriented communication technologies.

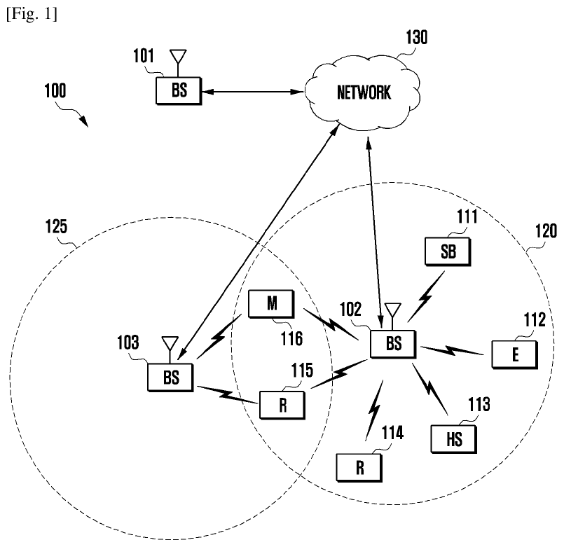

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 may communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

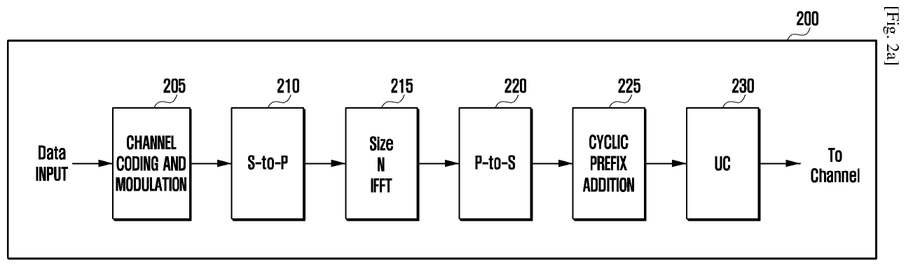

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

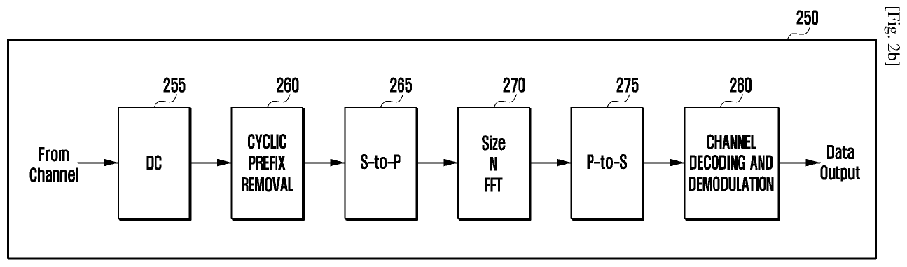

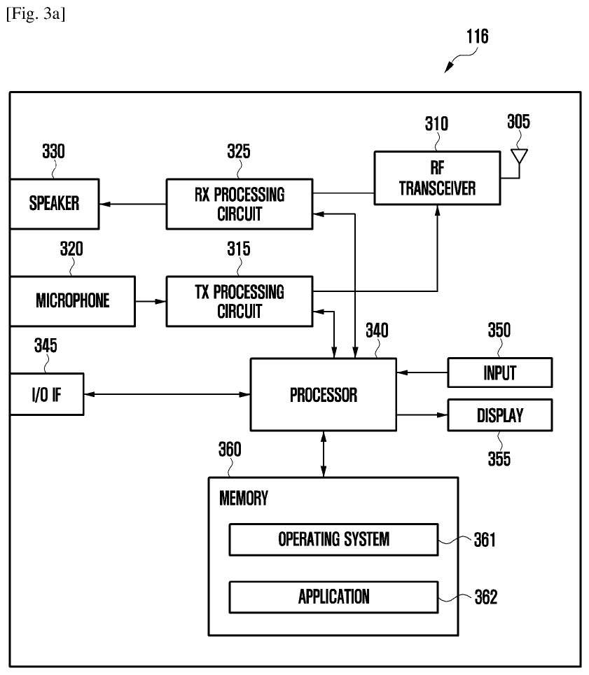

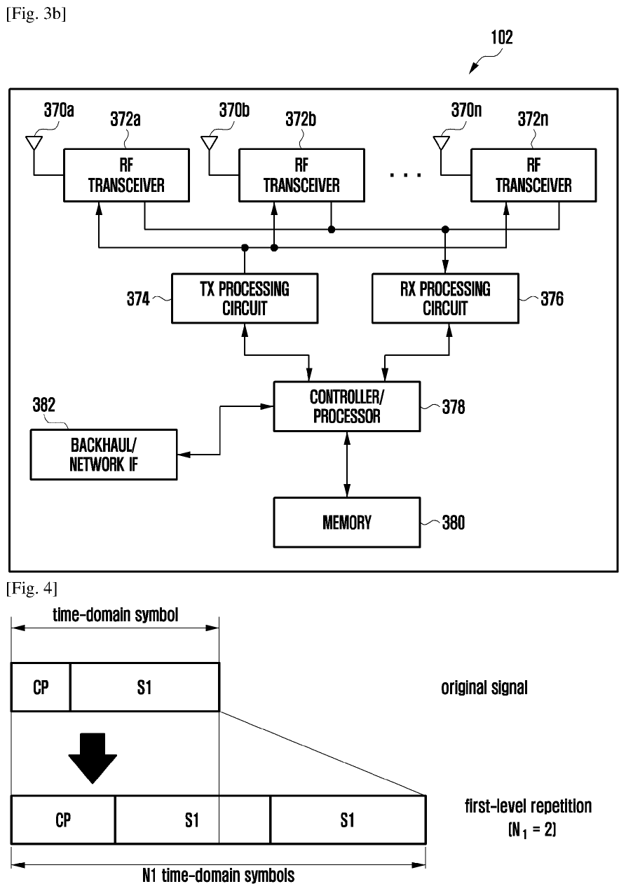

FIG. 3a illustrates an example UE 116 according to the present disclosure. The embodiment of UE 116 shown in FIG. 3a is for illustration only, and UEs 111-115 of FIG. 1 may have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. For example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 may move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 may input data into UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 may have the same or similar configuration. However, a gNB has various configurations, and FIG. 3b does not limit the scope of the present disclosure to any specific implementation of a gNB. It should be noted that gNB 101 and gNB 103 may include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 may include one or more processors or other processing devices that control the overall operation of gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a Blind Interference Sensing (BIS) process such as that performed through a BIS algorithm, and decode a received signal from which an interference signal is subtracted. A controller/processor 378 can support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the present disclosure. In some embodiments, the controller/processor 378 supports communication between entities such as web RTCs. The controller/processor 378 may move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 may include any number of each component shown in FIG. 3a. As a specific example, the access point may include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 may include multiple instances of each (such as one for each RF transceiver).

With the progress of science and technology, there are more and more kinds of communication devices. In addition to traditional mobile phones, computers and other devices, there are also mobile robots, such as self-driving vehicles, drones, etc., This type of mobile device often needs to have ability of precise positioning or ability to be precisely positioned, so as to identify current situation accurately and respond thereto, that is, to have positioning ability similar to that provided by radar technology. A direct way is to equip the communication device with a radar module. However, with the development of the operation frequency band of the communication system to a higher frequency band in recent years, the communication frequency band is gradually approaching the radar frequency band, and the resulting interference and resource conflict between the communication system and the radar system will be inevitable. One way to solve this issue is to consider a system fusing both communication and radar, which is called Integrated Sensing and Communication (ISAC), to further enhance functions of the communication system and improve spectrum efficiency. At present, both industry and academia regard the ISAC as one of the key technologies of future communication systems.

The core idea of the ISAC is to use one set of hardware devices to realize a function of perceiving the surrounding environment at a cost of as little resource overhead as possible while guaranteeing basic communication functions. The perceived content includes distances, orientations, speeds, even types etc., of objects within the surrounding environment. Unlike the technology of positioning an accessed terminal in a traditional communication system, the ISAC may also realize the perception of various information of non-access objects, which greatly increases the ability of the communication system to dynamically adjust operation state (scheduling, beam management, early warning of accessed terminals, etc.) according to the surrounding environment.

At present, the most widely used communication systems are those based on 3GPP protocols, e.g. 4G communication systems such as LTE and LTE-A, and 5G communication systems such as NR. The signal waveforms used in such communication systems are ones based on OFDM modulation. Considering forward compatibility, it is preferable to use the OFDM communication signal as a sensing signal. It should be noted that in designing a communication system, in order to avoid inter OFDM-symbol interference, it is necessary to add a cyclic prefix before every time-domain waveform, and the selection of length of the cyclic prefix depends on the maximum delay spread of a communication channel and cell coverage area. Although the longer the length of the cyclic prefix is, the larger the maximum delay spread and cell coverage area supported are, but considering the resource overhead, the cyclic prefix is usually not very long. It should be known that when used for perceiving purposes, the length of the cyclic prefix of the OFDM signal will also limit the perceiving range. And in order to increase the perceiving range, such as to perceive objects beyond the communication coverage area, a longer cyclic prefix is needed. How to increase the perceiving range without seriously affecting the transmission rate of the communication system will be a key issue for the ISAC system. And how to design the sensing signal to make it compatible with the existing communication systems is also an issue that needs to be considered.

In order to solve the above problems, the present application proposes a method of transmitting physical channel/signal, including a method for repetitively transmitting signals, a method for configuring parameters, a method for generating signals, etc., so that the repetitively transmitted signals can be used for the perception of targets in a large observing distance and are compatible with the existing communication systems.

A method of transmitting physical channel/signal is characterized in that a physical channel/signal is transmitted in two-level repetitions, wherein the two-level repetitions include a first-level repetition and a second-level repetition. The first-level repetition refers to a repetition performed one by one in units of a single time unit for respective signals that are on different time units of a set of time units allocated to a physical channel/signal, or an equivalent time domain signal repetition, wherein a time-domain signal refers to a signal resulting from performing inverse Fourier transform on a frequency-domain signal. The second-level repetition refers to a repetition performed on the first-level repeated physical channel/signal after the first-level repetition, in units of the first-level repeated physical channel/signal. Herein, a time unit may also be referred to as a time-domain unit. In one embodiment, a time unit may refer to a time-domain symbol (e.g., an OFDM symbol). In the following, “a time-domain symbol” may be used for description, but those skilled in the art will understand that other suitable time units may also be used in the embodiments involved. In addition, when referring to, for example, the time units allocated for physical layer data, it refers to the time units used for, for example, rate matching/time-domain data generation/calculation before the repetitive transmission of the physical layer data, and may also be referred to as “virtual time unit.” In addition, time units occupied by the physical layer data will also be mentioned herein, for example, to refer to time-domain resources used for the repetitive transmission of the physical layer data.

In one embodiment, the first-level repetition of a physical channel/signal may perform repetition for respective signals that are on different time units of the allocated set of time units in turn according to the mapping order of the transmission data, or may perform equivalent time-domain signal repetition. Such a design makes the repeatedly transmitted signal have two functional attributes, i.e., perception and communication. By the first-level repetition in units of a time-domain symbol, a longer cyclic prefix can be constructed. When this signal is used for the perception purpose, a distant target can be located. The second-level repetition is used to support a larger number of repetitions of signals, so as to meet the coverage requirement for the communication signals. Meanwhile, the longer cyclic prefix constructed by the first-level repetition can also be used to support a larger cell coverage, that is, to serve communication users at a longer distance. As a simplified way, when the number of repetitions in the second-level repetition is one (N₂=1), that is, only the first-level repetition is performed on the signal, the repeated signal can also be used for perceiving, only meeting communication requirements for a closer coverage. The repetitive transmission method is applicable for both uplink and downlink, and the applicable physical channels/signals include but are not limited to the physical downlink shared channel (PDSCH), the physical uplink shared channel (PUSCH), the channel state information reference signal (CSI-RS), the sounding reference signal (SRS) and the demodulation reference signal (DMRS). Specifically, when the physical channel/signal is for uplink, the transmission means specifically that a terminal transmits the physical channel/signal with the above features and the physical channel/signal is received by the base station. When the physical channel/signal is for downlink, the transmission means specifically that the terminal receives the physical channel/signal with the above features and the physical channel/signal is transmitted by the base station.

In the above features, one specific implementation of the “repetition performed one by one in units of a single time-domain symbol for respective signals that are on different time-domain symbols of a set of time-domain symbols allocated to a physical channel/signal” of the first-level repetition can be that the respective time-domain signal that is on each of the time-domain symbols allocated to the physical channel/signal is repeated end to end for N₁ times, with no cyclic prefix being added between different repetitive copies of the time-domain signal, and a cyclic prefix being added before the first copy of the time-domain signal, where N₁ indicates the number of repetitions in the first-level repetition and N₁ can be a configurable value or a value fixed by protocol. The value of N₁ can be odd (e.g., 3, 5, . . . ) or even (e.g., 2, 4, . . . ). In one embodiment, the value of N₁ is a power of 2, in order to be compatible with the configuration of the number of repetitions which is a power of 2 in the existing protocols. Take N₁=2 as an example, FIG. 4 illustrates a schematic diagram of the first-level repetition. In the schematic diagram of FIG. 4, it is assumed that only one time-domain symbol (e.g., one OFDM symbol) is allocated to the physical layer data. As shown in the upper part of FIG. 4, in a traditional method, a signal over a time-domain symbol consists of a cyclic prefix (CP) and a time-domain signal (S1). That is, as shown in FIG. 4, S1 represents the original time-domain signal that is on an allocated time-domain symbol. The process of the first-level repetition is that S1 is repeated N₁ times continuously, there is no cyclic prefix between the N₁,S1s, and a cyclic prefix is added only before the first S1. In one embodiment, when the number of repetitions in the first-level repetition is N₁, the number of time-domain symbols occupied by the first-level repetition is N₁, and a length of a cyclic prefix of the first-level repetition is a sum of lengths of the cyclic prefixes of the occupied N₁ time-domain symbols, i.e.,

$${N}_{CP , 1 step} = {\sum }_{k = {i}_{1}}^{{i}_{{N}_{1}}} {N}_{C P} [ k ] ,$$

where N_{cp,1step} indicates the length of the cyclic prefix of the first-step repetition, Nₑₚ[k] indicates the length of the cyclic prefix of the time-domain symbol with an index of k, and iₓ indicates an index of the x-th time-domain symbol of the N₁ time-domain symbols occupied by the first-level repetition. Such a design can guarantee that the end of the first-level repeated time-domain signal (also called “first-level repeated signal” or simply “first-level repetition”) is aligned with the boundary of a time-domain symbol (e.g., an OFDM symbol). Particularly, when the lengths of the cyclic prefixes of the N₁ time-domain symbols occupied by the first-level repetition are the same, the length of the cyclic prefix of the first-level repetition is N_{CP,1step}=N₁·N_{CP}, Where N_{CP} indicates the length of a cyclic prefix of a single time-domain symbol.

In one embodiment, the N₁ time-domain symbols occupied by the first-level repetition of the time-domain signal over a single time-domain symbol in the set of time-domain symbols allocated to the physical channel/signal are temporally-continuous time-domain symbols, that is, the first-level repetition of the time-domain signal over a same time-domain symbol cannot be interrupted, so as to guarantee that a previous repetition can be used as a cyclic prefix of the next repetition, thereby expanding the sensing coverage. The time-domain symbols occupied by the first-level repetitions of the time-domain signals over different time-domain symbols in the set of time-domain symbols allocated to the physical channel/signal can be either temporally-continuous or temporally-discontinuous, that is, the first-level repetitions of the time-domain signals over different time-domain symbols can be interrupted.

When the above-described specific implementation of first-level repetition is employed, the total number N of repetitive transmissions of the physical channel/signal can be calculated as: N=N₁×N₂, where N₁, N₂ and N are all positive integers, and at least one of N₁, N₂ and N is a configurable parameter. In one embodiment, N₁ is a fixed value in protocol, e.g., N₁=2, and N₂ is a configurable parameter, which can be obtained by a terminal according to high-layer signaling or DCI or MAC signaling. Alternatively, N₂=N/N₁ can be calculated according to the values of N₁ and N₁ where N is a configurable parameter, which can be obtained by the terminal according to higher layer signaling or DCI or MAC signaling. Alternatively, N₁ can be configured by configuring the number of time-domain symbols occupied by the first-level repeated signal of the time-domain signal over a single time-domain symbol in the set of time-domain symbols allocated for the transmission or reception of the physical channel/signal.

In the design of the first-level repetition, no cyclic prefix is inserted among the plurality of repetitions of the time-domain signal over a same allocated time-domain symbol, so that a previous repetition can be used in whole as the cyclic prefix of the next one, and two repetitions may already provide a cyclic prefix with a length of nearly one time-domain symbol, which is sufficient for the perceiving purposes. In addition, the introduction of the first-level repetition will increase transmission time of a complete data packet or a complete sequence of the physical channels/signals. Therefore, in order to avoid affecting early decoding by the receiver (the decoding can only be performed when all the time-domain symbols of the received first-level repetition have been buffered and the complete data has been obtained), the number of repetitions in the first-level repetition should be as small as possible. The configuration of the number of repetitions N₂ of the second-level repetition (or the total number of repetitions N) can be used to guarantee uplink or downlink coverage of a terminal for communication purposes.

Or alternatively, another specific implementation of the first-level repetition given below can implement “equivalent of repetition performed one by one in units of a single time-domain symbol for respective time-domain signals that are on different time-domain symbols of a set of time-domain symbols allocated to a physical channel/signal”. Another specific implementation of the first-level repetition is to employ a specific frequency-domain mapping approach for the physical channel/signal. The specific frequency-domain mapping approach may include mapping the physical channel/signal onto subcarriers with even indexes, and a spacing between the mapped adjacent subcarriers (hereinafter also referred to as frequency mapping density or subcarrier mapping spacing) is also even. Meanwhile, the subcarriers with odd indexes within the time-domain symbol to which the physical channel/signal is mapped are unavailable subcarriers. Further, when it is assumed that the physical channel/signal is for uplink, the subcarriers with odd indexes are unavailable to uplink. When it is assumed that the physical channel/signal is for downlink, the subcarriers with odd indexes are unavailable to downlink.

For example, the values of the subcarrier indexes to which the physical channel/signal is mapped is subjected to Δ_{sc}·k, k=0, 1, . . . , where the subcarrier mapping spacing Δ_{SC} of subcarriers to which the physical channel/signal is mapped in frequency domain may be a power of 2 (such as 2, 4, 8, etc.), and may be a configured value or a fixed value in protocol. FIG. 5 shows an example of employing this frequency-domain mapping approach. According to the nature of the Fourier transform, the time-domain signals resulting from the Fourier transform performed on the frequency-domain data are equivalent to a number Δ_{sc} of repetitions of short time-domain data with a short length (the length of the short time-domain data being repeated is

$$\frac{{N}_{FFT}}{{⋀}_{SC}} ) ,$$

At this time, a previous repetition can be used as an equivalent cyclic prefix of the next repetition, and then the size of the equivalent cyclic prefix is a length in number of points, i.e.,

$$\frac{{N}_{FFT}}{{⋀}_{SC}} ,$$

which is much larger than the established length of cyclic prefix of the time-domain symbol, where N_{FFT} is the number of points for the Fourier transform corresponding to the subcarrier spacing of the physical channel/signal. In order to improve the coverage of the sensing signal, the value of Δ_{SC} can be reduced or the value of N_{FFT} can be increased. The method for increasing N_{FFT} may be to configure a smaller subcarrier spacing for the physical channel/signal. Preferably, the value of Δ_{SC} is 2 and may be a fixed value. Alternatively, the subcarrier mapping spacing Δ_{SC} is related to the subcarrier spacing of the physical channel/signal, and can be obtained according to a configuration for the subcarrier spacing of the physical channel/signal, e.g.,

$${Δ}_{SC} = \frac{Δ f}{Δ {f}_{sp}} ,$$

where Δ_{f} is the subcarrier spacing of the bandwidth part where the frequency-domain resources allocated to the physical channel/signal by higher layer signaling are located, and Δfₛₚ is the subcarrier spacing configured for the physical channel/signal, which may also be called configured subcarrier spacing. In one embodiment, the physical channel/signal can be configured with a subcarrier spacing, wherein the configuration information regarding the subcarrier spacing can be carried and transmitted by at least one of high-layer signaling, downlink control information (e.g., downlink control information scheduling the physical channel/signal), MAC control information, etc.

More specifically, the configured subcarrier spacing may be a configuration parameter configured for a specific physical channel/signal, or a configuration parameter configured for one or more specific transmissions or schedules of a specific physical channel/signal. Alternatively, the configured subcarrier spacing may be associated with a specific physical resource. For example, the configured subcarrier spacing is applicable to the physical channel/signal transmitted within the specific physical resource, wherein the specific physical resource may be specific time-domain symbols and/or a specific bandwidth (e.g., a plurality of continuous physical resource blocks), thereby ensuring that the transmitted physical channel/signal can guarantee sufficient sensing coverage when the specific physical resource is used for transmitting and receiving sensing signals. Alternatively, the configured subcarrier spacing may be determined by frequency-domain mapping density Δ_{sc}. For example, the configured subcarrier spacing may be

$$\frac{⋀ f}{{⋀}_{SC}} ,$$

where Δ_{f} is the subcarrier spacing of the bandwidth part where the frequency-domain resources configured to the physical channel/signal through higher layer signaling are located. That is, the subcarrier spacing of the physical channel/signal is reduced proportionally when the above frequency-domain mapping approach is employed. Such design takes into account that the proposed frequency-domain mapping approach is equivalent to repetition of time-domain signals, and the length of the time-domain symbol can be expanded in a proportion by reducing the subcarrier spacing in an equal proportion, thereby guaranteeing that a ratio of the length of the first-level repeated time-domain signal over a single time-domain symbol to the length of the cyclic prefix remains unchanged, and no additional overhead occurs. Still further, the length of the cyclic prefix corresponding to the configured subcarrier spacing is taken as the length of the cyclic prefix for generating a baseband signal for the physical channel/signal. Similarly, the number of repetitions N₂ in the second-level repetition is a configurable parameter, which can be obtained by a terminal according to higher layer signaling or DCI or MAC signaling. Alternatively, x₂=N/Δ_{SC}, and N₂ can be calculated according to the values of Δ_{SC} and N, where N is a configurable parameter, which can be obtained by the terminal according to higher layer signaling or DCI or MAC signaling.

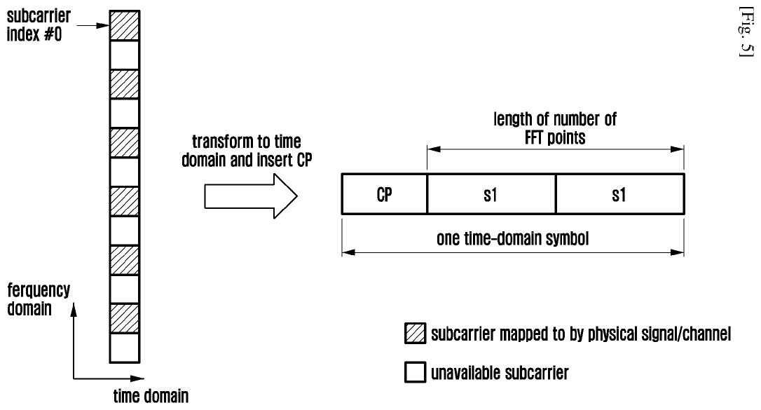

Taking the first implementation of the first-level repetition as an example, FIG. 6 shows an example of a method of repetitive transmission of physical channel/signal. Let N₁=N₂=2, the physical channel/signal is PDSCH, the allocated time-domain resources are 6 time-domain symbols with indexes of 3-8 in a slot, and the time-domain symbols with indexes of 3 and 8 are used for demodulation reference signal (DMRS), then the total number of the time-domain symbols to which a single transport block equivalently used for the PDSCH is mapped is 4. In order to be distinguished from actually occupied time-domain symbols, the time-domain symbols for the time-domain resources allocation are called virtual time-domain symbols below, that is, one transport block of the PDSCH is mapped onto 4 virtual time-domain symbols. As shown in FIG. 6, the PDSCH signals over different virtual time-domain symbols are first-level repeated one by one, and the respective first-level repetition of each virtual time-domain symbol occupies temporally-continuous time-domain resources, i.e., two continuous time-domain symbols. The time-domain resources occupied by the first-level repetitions of different virtual time-domain symbols may be either continuous or discontinuous. In this example, the first-level repetitions span two slots and occupy time-domain symbols at the same positions in two slots. The second-level repetition is repeated in units of the two slots of the first-level repetitions, and the number of repetitions in the second-level repetition is 2, meaning that the two slots of the first-level repetitions are transmitted twice.

Particularly, when a DMRS of the PDSCH (or PUSCH) employs two-level repetitive transmission, a specific implementation may be that in a two-level repetitive transmission of the DMRS, a number of repetitions N₂ in the second-level repetition is N₂=1, that is, only the repetition in the units of time-domain symbol is performed for each DMRS sequence. The DMRS sequence is generated according to the index of the first one of the time-domain symbols occupied by the first-level repetition. This is because that the base sequence generation of the DMRS is related to the time-domain position of the DMRS. The time-domain position of the DMRS would change if the DMRS was repeated a plurality of times, in which case different sequences should be generated separately, and cannot be repeated twice as a whole. Moreover, when the DMRS of the PDSCH (or the PUSCH) adopts the two-level repetitive transmission, a multiplexing of the PDSCH (or the PUSCH) and the DMRS is not supported, that is, transmitting both the DMRS and the PDSCH (or the PUSCH) simultaneously on same time-domain symbols is not supported. In addition, when the DMRS of the PDSCH (or the PUSCH) adopts two-level repetitive transmission, in calculating the number of resource elements (REs) allocated to the PDSCH (or the PUSCH), the calculation of the number of the REs occupied by the DMRS should involve all REs over all time-domain symbols occupied by the first-level repetition of the DMRS.

It should be noted that the first-level repetition of the signal over a same time-domain symbol allocated to the physical channel/signal needs to occupy N₁ continuous time-domain symbols, and the number of repetitions N₁ of the first-level repetition is even (power of 2), with a typical value of 2, that is, the first repetition of the respective signal over each time-domain symbol allocated to the physical channel/signal needs to occupy 2 continuous time-domain symbols. If the number of continuous time-domain symbols allocated to the physical channel/signal is odd, it cannot be supported that the two-level repetition is applied for all time-domain symbols of the complete data of the physical channel/signal. Or alternatively, when the physical channel adopting the two-level repetition is the PDSCH or the PUSCH, even if the allocated time-domain symbol resources are an even number of time-domain symbols, they may be divided into a plurality of segments with an odd number of time-domain symbols due to the existence of the DMRS, therefore affecting the realization of the first-level repetition. For example, according to an indication of an time-domain resource allocation, the time-domain resources allocated to the PDSCH are 6 time-domain symbols with indexes of #3~#8 in a slot. According to the existing NR protocols, the time-domain symbols occupied by the DMRS are two time-domain symbols with indexes of #3 and #7. Thus, the actual available time-domain symbols for the PDSCH are #4~#6 and #8, that is, the time-domain symbols for the PDSCH are divided into two segments, with each having an odd number of time-domain symbols. While the total number of available time-domain symbols is 4, they can only support two first-level repetitions for one time-domain symbol allocated to the physical channel/signal. With respect to an odd number of continuous time-domain symbols allocated to the physical channel/signal, a method of hybrid two-level repetition is proposed below, to perform the two-level repetition on signals over part of the time-domain symbols allocated to the PDSCH. Moreover, with respect to a case where the continuous time-domain symbols of the PDSCH or the PUSCH are divided by the DMRS, a method for determining time-domain position for the DMRS is also proposed below, for adjusting the position of the DMRS so as to guarantee the implementation of the two-level repetitive transmission of the PDSCH or the PUSCH.

A method of transmission of physical channel/signal also comprises a method of partial two-level repetition. When a physical channel/signal is repeatedly transmitted, among the time-domain symbols allocated to the complete data/complete sequence of the physical channel/signal, a repetitive transmission approach for part of the time-domain symbols includes the first-level repetition, while a repetition transmission approach for the other part of the time-domain symbols does not include the first-level repetition. FIG. 7 shows an example where N₁=N₂=2, the physical channel/signal is the PDSCH, the allocated time-domain resources are 7 time-domain symbols with indexes of 3-9 in a slot, and the time-domain symbols with indexes of 3 and 8 are used for the demodulation reference signal (DMRS), then a total number of the time-domain symbols to which a single transport block of the PDSCH is mapped is 5 equivalently. Therefore, the allocated time-domain symbols in one slot can support at most the first-level repetitions of two time-domain symbols. In order to be differentiated from the actually occupied time-domain symbols, the time-domain symbols for the time-domain resources allocation are defined below as virtual time-domain symbols, thus one transport block of the PDSCH is mapped onto 5 virtual time-domain symbols. As shown in FIG. 7, the PDSCH virtual symbols (VS) #0~#3 are first-level repeated one by one, and the first-level repetition of each virtual time-domain symbol occupies temporally-continuous time-domain resources, i.e., two continuous time-domain symbols, and the time-domain resources occupied by the first-level repetitions of different virtual time-domain symbols may be either continuous or discontinuous. The last virtual time-domain symbol #4 of the PDSCH is not first-level repeated, instead it is repeatedly transmitted on the last one of the odd number of continuous time-domain symbols allocated to the PDSCH in each slot. In this example, the first-level repetition of all virtual time-domain symbols of the physical channel/signal spans two slots, and occupies time-domain symbols at the same positions in the two slots (it is assumed that the positions of time-domain symbols that can be used for the PDSCH repetitive transmission in different slots are the same). The second-level repetition is performed in units of two slots of the first-level repetition. The number of repetitions in the second-level repetition being 2 means that the two slots of the first-level repetition are transmitted twice.

A method for transmitting a physical channel/signal further comprises a method for determining time-domain position of a DMRS for the PDSCH (or the PUSCH) in which: a terminal determines a position of a time-domain symbol of the DMRS according to at least one or more of a repetition type of the PDSCH (or the PUSCH), an indication of time-domain position offset of the DMRS, and an indication of time-domain position of the DMRS.

Specifically, a specific implementation for a terminal to obtain a position of a time-domain symbol of a DMRS according to the indication of time-domain position offset of the DMRS may include that the terminal obtains the indication of time-domain position offset of the DMRS and determines the position offset of at least one of the time-domain symbols to which the DMRS is mapped in a same slot, wherein the terminal obtains the indication of time-domain position offset of the DMRS by at least one of higher layer signaling, downlink control information, and MAC control information. For example, the specific content of the indication of time-domain position offset of the DMRS may indicate that an index value of a time-domain symbol of a specific DMRS, within a slot scheduled for the PDSCH (or the PUSCH), is increased or decreased by N₁ where N is a positive integer. In one embodiment, the value of N is 1. In one embodiment, the time-domain symbol of the specific DMRS may be a time-domain symbol of an additional DMRS, i.e., a DMRS other than the time-domain symbol for transmitting the first DMRS sequence within the scheduled slot. Such design takes into account that in the current protocol, the position of the time-domain symbol for transmitting the first DMRS sequence is fixed (e.g., the first time-domain symbol, or the time-domain symbol with a fixed index of #3 or #4, of the time-domain resources scheduled for the PDSCH), and improper division of continuous time-domain symbols for the PDSCH can be avoided through appropriate PDSCH (or PUSCH) time-domain resource allocation. On the other hand, the position of the time-domain symbol of the additional DMRS is not fixed, which is more likely to cause improper division of continuous time-domain symbols of the PDSCH (or the PUSCH), so the above issues can be solved by offsetting only the position of the time-domain symbol of the additional DMRS. For example, according to the above features, the specific method for determining the position(s) of time-domain symbol of the DMRS can be:

$$l = \overline{l} + {l}^{′} + Δ {l}_{DMRS} ,$$

where 1 indicates an index of a time-domain symbol to which a DMRS is mapped, l̅ indicates a position of a PDSCH (or a PUSCH) DMRS (e.g., according to 1 protocol of TS 38.211, it is determined through higher layer signaling dmrs-AdditionalPosition and the number/of continuous symbols configured for the PDSCH (or the PUSCH), as shown in Table 6.4.1.1.3-3, Table 6.4.1.1.3-4, and Table 6.4.1.1.3-6 in TS 38.211), and

$${l}^{′} = \{ \begin{matrix}0 & single symol DMRS \\ 0 , 1 & double symbol DMRS\end{matrix}$$

is a temporal index of the PDSCH (or the PUSCH) DMRS. Δl_{DMRS} is a time-domain position offset of DMRS, which is determined by indication information and is applicable to only time-domain symbol of the additional DMRS, and can be expressed as:

$${Δl}_{DMRS} = \{ \begin{matrix}0 , & \overline{l} = {l}_{0} \\ - 1 or 1 , & \overline{l} \neq {l}_{0}\end{matrix}$$

where l₀ indicates a time-domain symbol of the first DMRS within a scheduled slot, and a time-domain symbol of the additional DMRS can be represented as l̅≠l₀, in which case Δl_{DMRS} is determined as one of {−1,1} by information of the indication of time-domain position offset of the DMRS.

Moreover, specifically, a specific implementation for a terminal to obtain a position of time-domain symbol of DMRS according to an indication of time-domain position of DMRS and an indication of repetition type of the PDSCH (or the PUSCH) may be that the terminal determines indication field of time-domain position of the DMRS according to the indication of repetition type of the PDSCH (or the PUSCH). For example, the indication of repetition type of the PDSCH (or the PUSCH) may indicate whether the PDSCH (or the PUSCH) employs the two-level repetition, and the indication of time-domain position of the DMRS may be one or more pieces of indication information (such as higher layer signaling dmrs-AdditionalPosition) associated with determining indexes of the time-domain symbols to which the DMRS is mapped. A specific example of this implementation may be that the terminal determines the indication field of time-domain position of DMRS according to whether the PDSCH (or the PUSCH) adopts the two-level repetition. When the PDSCH (or the PUSCH) uses the two-level repetition, the terminal obtains an indication message for indicating position of indication field of time-domain position of the DMRS, and determines an index of the time-domain symbol to which the DMRS is mapped according to the indication field associated with the two-level repetition approach. When the repetition type of the PDSCH (or the PUSCH) is different (e.g., two-level repetition/non-two-level repetition), the number of indications of time-domain position of the DMRS obtained by the terminal is different, and/or the corresponding relationship between the bit content of the indication information and the indicated time-domain position of the DMRS is different, that is, the indication field is different. In one embodiment, when the repetition type of the PDSCH (or the PUSCH) is the two-level repetition, the amount of information of the indication of time-domain location of the DMRS obtained by the terminal is larger than that for non-two-level repetition, and/or the indication field of time-domain location of the DMRS is larger than that for the non-two-level repetition, that is, a larger number of bits for the indication of time-domain location of the DMRS may indicate more time-domain locations for the DMRS. This design takes into account the requirement of two-level repetition for continuity of time-domain symbols, and supports different indication messages and/or different indication field for indicating time-domain position of the DMRS under the two-level repetition, so as to achieve a better implementation of the two-level repetition.

A method for transmitting physical channel/signal further comprises a method for determining time-domain position of the DMRS for the PDSCH (or the PUSCH), in which: a terminal determines whether to adjust a position of time-domain symbol of the DMRS in a preset way according to the relative relationship between the PDSCH (or the PUSCH) time-domain resource allocation and the DMRS time-domain symbol position. In one embodiment, the prerequisite for the above operations is that the repetition type of the PDSCH (or the PUSCH) is a specific repetition type, for example, the two-level repetition proposed by the present application is adopted. The considered relative relationship between the PDSCH (or the PUSCH) time-domain resource allocation and the DMRS time-domain symbol position may mean the number of time-domain symbols included in each segment of time-domain symbols, among a plurality of segments of continuous time-domain symbols resulting from the DMRS time-domain symbols dividing the time-domain resources allocated for the PDSCH (or the PUSCH), or the parity feature of the above number. The preset way for adjusting position of time-domain symbol of the DMRS can be to add N_{offset} to or subtract N_{offset} from the index value of at least one specific DMRS time-domain symbol, where N_{offset} is a preset value and is an integer, for example, N_{offset}=1, 2, . . . , etc. In one embodiment, the at least one specific DMRS time-domain symbol may be time-domain symbols of an additional DMRS, i.e., the DMRS other than the time-domain symbol transmitted by the first DMRS sequence within a scheduled slot. A specific example may be that, supposing that the time-domain resources allocated for the PDSCH (or the PUSCH) are divided into K segments of continuous time-domain symbols by the DMRS time-domain symbols, wherein the number of time-domain symbols included in the i-th (i∈{1, 2, . . . , k}) segment of time-domain symbols is denoted as NSᵢ. When the repetition type of the PDSCH (or the PUSCH) is two-level repetition, if at least one of NSᵢ, i=1, 2, . . . , K is odd, the index value of time-domain symbol of the additional DMRS is subtracted by N_{offset}, where N_{offset}=1.

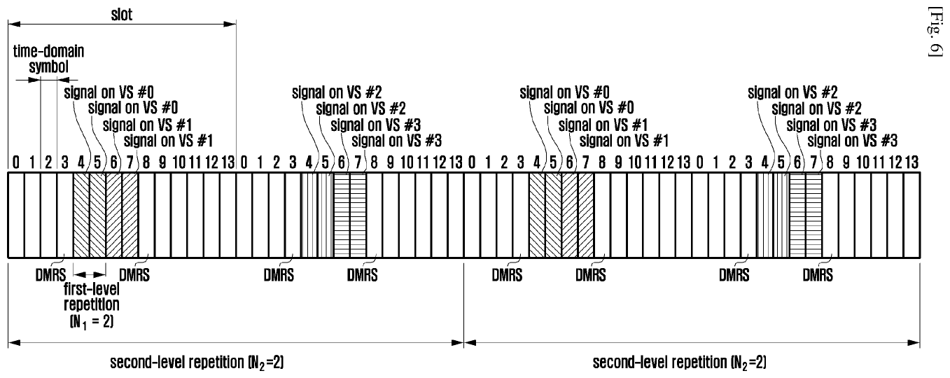

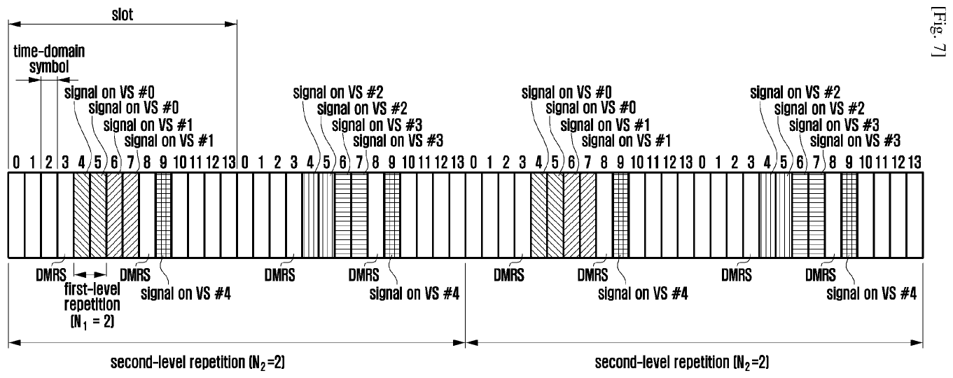

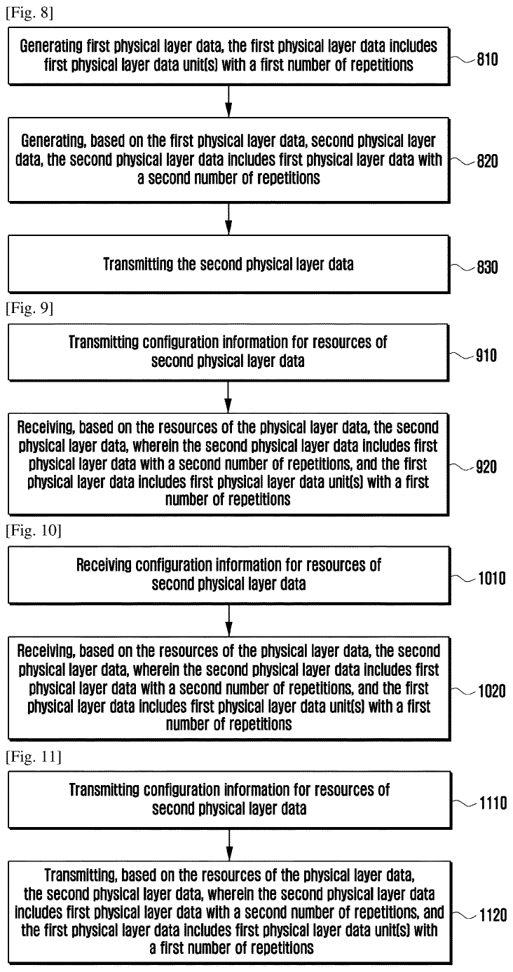

FIG. 8 shows an exemplary flowchart of a communication method 800 performed by a first node in a wireless communication system according to an embodiment of the present disclosure. In one embodiment, the first node may be one or more of the user equipments 111-116 in FIG. 1 or 3a. The method 800 may comprise: in step 810, generating first physical layer data, wherein the first physical layer data includes first physical layer data unit(s) with a first number of repetitions; in step 820, generating, based on the first physical layer data, second physical layer data, wherein the second physical layer data includes the first physical layer data with a second number of repetitions; and in step 830, transmitting the second physical layer data.

In one embodiment, optionally, generating the first physical layer data in step 810 may comprise: generating at least one first physical layer data unit(s) based on a physical signal or channel; and generating, for each of all or part of the at least one first physical layer data unit(s), a first repetition physical layer data unit being on the first number of time-domain units, wherein each first repetition physical layer data unit includes a cyclic prefix and the first physical layer data unit with the first number of repetitions.

In one embodiment, optionally, the length of the cyclic prefix may be a sum of the lengths of respective cyclic prefixes of the first number of the time-domain units. And optionally, the first number of the time-domain units may be the first number of continuous time-domain units.

In one embodiment, optionally, the first physical layer data in step 810 may be a baseband signal. Optionally, generating the first physical layer data in step 810 may comprise: generating at least one data symbol(s) based on a physical signal or channel. For example, for a physical signal, the at least one data symbol(s) may be at least one modulated symbol; and for a physical channel, the at least one data symbol(s) may be a sequence. Generating the first physical layer data in step 810 may further comprise: for each data symbol of the at least one data symbol(s), mapping the data symbol onto subcarrier(s) with predetermined subcarrier index(es) to obtain a frequency-domain signal; and generating, based on the frequency-domain signal, a first repetition physical layer data unit being on one time-domain unit, wherein the first repetition physical layer data unit includes a cyclic prefix and the first physical layer data unit with the first number of repetitions.

In one embodiment, optionally, mapping the data symbol onto the subcarriers with the predetermined subcarrier indexes may comprise: mapping the data symbol onto the subcarriers with even indexes at a subcarrier mapping spacing, wherein the subcarrier mapping spacing corresponds to the first number. Optionally, subcarriers with odd indexes within the time-domain unit corresponding to each of the at least one data symbol(s) may be unavailable subcarriers.

In one embodiment, optionally, the subcarrier mapping spacing may have a configurable value, or the subcarrier mapping spacing may has a fixed value. Optionally, the subcarrier mapping spacing may have a value of 2.

In one embodiment, optionally, the subcarrier mapping spacing may be configured by at least one of a higher layer signaling, downlink control information, or media access control (MAC) control information.

In one embodiment, optionally, the subcarrier mapping spacing may be for specific physical layer data, or may be for specific one or more transmissions of specific physical layer data, or may be for specific physical resources.

In one embodiment, optionally, the subcarrier mapping spacing may be configured by configuring a configured subcarrier spacing for transmission of the physical channel or signal. Optionally, the length of the cyclic prefix may be a length of a cyclic prefix corresponding to the configured subcarrier spacing.

In one embodiment, optionally, the first number may be an even number, or the first number may be a power of 2. Optionally, at least one of the first number, the second number and the total number may be a configurable parameter, wherein the total number is a product of the first number and the second number. Optionally, the second number may be a value greater than or equal to 1.

In one embodiment, optionally, the physical channel or signal in the method 800 may comprises at least one of a physical uplink shared channel (PUSCH), a sounding reference signal (SRS) or a demodulation reference signal (DMRS)

In one embodiment, optionally, the number of first physical layer data units among the at least one first physical layer data unit(s) that are associated with the first number of continuous time-domain units may be determined based at least in part on the number of continuously allocated time-domain units allocated to the physical channel or signal and the first number.

In one embodiment, optionally, when the first physical layer data occupies a plurality of slots, the first physical layer data may occupy time-domain units at the same position in the plurality of slots.

In one embodiment, when the physical channel or signal is a physical uplink shared channel (PUSCH), optionally, the method 800 may further comprise: determining position(s) of time-domain unit for a demodulation reference signal (DMRS) based on at least one of indication(s) of repetition type of the PUSCH, indication(s) of time-domain position offset of the DMRS, or indication(s) of time-domain position of the DMRS.

In one embodiment, optionally, determining the position(s) of time-domain unit of the DMRS may comprise: obtaining the indication(s) of time-domain position offset of the DMRS, determining the position(s) of time unit of the DMRS based on the obtained indication(s) of time-domain position offset of the DMRS, wherein the indication(s) of time-domain position offset of the DMRS is obtained by at least one of a higher layer signaling, downlink control information and MAC control information. Optionally, the indication of time-domain position offset of the DMRS may be used for indicating an index value of at least one of the time-domain units to which the DMRS is mapped to be increased or decreased by N₁ where N is a positive integer, and N may be a configured value or a fixed value in protocol.

In one embodiment, optionally, the method 800 may further comprise determining indication message(s) for indicating time-domain position of the DMRS according to the indication of repetition type of the PUSCH. Optionally, when the repetition type of the PUSCH is two-level repetition, the number of indication messages for indicating time-domain position of the DMRS may be greater than the number of indication messages for indicating time-domain position of the DMRS when the repetition type of the PUSCH is not the two-level repetition. Optionally, when the repetition type of the PUSCH is the two-level repetition, the length of the indication message for indicating time-domain position of the DMRS may be greater than the length of the indication message for indicating time-domain position of the DMRS when the repetition type of the PUSCH is not the two-level repetition.

In one embodiment, when the physical channel or signal is a physical uplink shared channel (PUSCH), optionally, the method 800 may further comprise determining whether to adjust a position of at least one of the time-domain units to which the DRMS is mapped in a preset way based at least in part on a relative position relationship between a set of time-domain units allocated to the physical channel or signal and the time-domain units to which the DMRS is mapped. Optionally, at least one of the time-domain units to which the DMRS is mapped may be the time-domain units other than the first time-domain unit among the time-domain units to which the DMRS is mapped. Optionally, adjusting the position of at least one of the time-domain units to which the DMRS is mapped in the preset way may comprise increasing or decreasing the index value of the at least one time-domain unit by a preset offset value.

FIG. 9 illustrates an exemplary flowchart of a communication method 900 performed by a second node in a wireless communication system according to an embodiment of the present disclosure. In one embodiment, the second node may be one or more of the gNBs 101-103 in FIGS. 1 and 3b. The method 900 may comprise, in step 910, transmitting configuration information for resources of second physical layer data. Optionally, the configuration information for the resources of the second physical layer data may be dynamically configured through DCI, or may be semi-statically configured. The method 900 may further comprise, in step 920, receiving, based on the resources of the physical layer data, the second physical layer data, wherein the second physical layer data includes first physical layer data with a second number of repetitions, and the first physical layer data includes first physical layer data unit(s) with a first number of repetitions.

FIG. 10 illustrates an exemplary flowchart of a communication method 1000 performed by a first node in a wireless communication system according to an embodiment of the present disclosure. In one embodiment, the first node may be one or more of the user equipments 111-116 in FIG. 1 or 3a. In one embodiment, the method 1000 may comprise, in step 1010, receiving configuration information for resources of second physical layer data. Optionally, the configuration information for the resources of the second physical layer data may be dynamically configured through DCI, or may be semi-statically configured. The method 1000 may further comprise: in step 1020, receiving, based on the resources of the physical layer data, the second physical layer data, wherein the second physical layer data may include first physical layer data with a second number of repetitions, and the first physical layer data may include first physical layer data unit(s) with a first number of repetitions.

FIG. 11 illustrates an exemplary flowchart of a communication method 1100 performed by a second node in a wireless communication system according to an embodiment of the present disclosure. In one embodiment, the second node may be one or more of the gNBs 101-103 in FIGS. 1 and 3b. In one embodiment, the method 1100 may comprise, in step 1110, transmitting configuration information for resources of second physical layer data. Optionally, the configuration information for the resources of the second physical layer data may be dynamically configured through DCI, or may be semi-statically configured. The method 1100 may further comprise: in step 1120, transmitting, based on the resources of the physical layer data, the second physical layer data, wherein the second physical layer data may include first physical layer data with a second number of repetitions, and the first physical layer data may include first physical layer data unit(s) with a first number of repetitions.

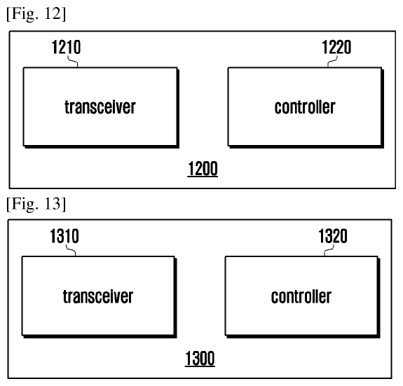

FIG. 12 illustrates an exemplary block diagram of a wireless communication device 1200 according to an embodiment of the present disclosure. The wireless communication device 1200 may be the first node in the above. In one embodiment, the wireless communication device 1200 may include a transceiver 1210 and a controller 1220. The controller 1220 may be coupled with the transceiver 1210 and may be configured to perform at least some steps of the methods 800 and 1100, for example. In one embodiment, for example, the wireless communication device 1200 may be a user equipment as shown in FIG. 3a.

FIG. 13 shows an exemplary block diagram of another wireless communication device 1300 according to an embodiment of the present disclosure. The wireless communication device 1300 may be the second node in the above. In one embodiment, the wireless communication device 1300 may include a transceiver 1310 and a controller 1320. The controller 1320 may be coupled with the transceiver 1310 and may be configured to perform at least some steps of the methods 900 and 1200, for example. In one embodiment, for example, the wireless communication device 1300 may be a base station as shown in FIG. 3b.

The present disclosure also provides a computer-readable medium having stored thereon computer-executable instructions, which, when executed, cause a processor to perform any of the methods described in the embodiments of the present disclosure.

The embodiments of the present disclosure have been described in detail above with reference to the accompanying drawings. While the present disclosure contains many specific implementation details, these should not be interpreted as limitations on the scope of any invention or the scope that may be claimed, but rather as descriptions of the features specific to specific embodiments of specific inventions. Certain features described in this specification in the context of separate embodiments may also be implemented in combination in a single embodiment. On the contrary, various features described in the context of a single embodiment may also be implemented separately or in any suitable sub-combination in multiple embodiments. Furthermore, although features may be described above as functioning in certain combinations, and even claimed as such at first, one or more features from the claimed combination may be deleted from the combination in some cases, and the claimed combination may be directed to a sub-combination or a variation of a sub-combination.

Similarly, although the operations are described in a specific order in the drawings and the specification, this should not be understood as requiring that these operations be performed in the specific order or sequential order shown, or that all the operations shown be performed, in order to achieve desired results. In some cases, multitasking and parallel processing may be advantageous. Furthermore, the division of various system components in the above embodiments should not be understood as requiring such division in all embodiments, and it should be understood that the described components and systems can generally be integrated together in a single product or packaged into multiple products.

Therefore, specific embodiments of the subject matter have been described. Other embodiments are also within the scope of the claims. In some cases, the operations described in the claims may be performed in a different order and still achieve desired results.

1. A method of a first node in a wireless communication system, comprising:
generating first physical layer data, wherein the first physical layer data includes first physical layer data unit with a first number of repetitions;
generating, based on the first physical layer data, second physical layer data, wherein the second physical layer data includes the first physical layer data with a second number of repetitions; and
transmitting the second physical layer data.

2. The method of claim 1, wherein generating the first physical layer data comprises:
generating at least one first physical layer data unit based on a physical signal or channel; and
generating, for each of all or part of the at least one first physical layer data unit, a first repetition physical layer data unit being on the first number of time-domain units, wherein each first repetition physical layer data unit includes a cyclic prefix and the first physical layer data unit with the first number of repetitions,
wherein the length of the cyclic prefix is a sum of lengths of respective cyclic prefixes of the first number of time-domain units, and
wherein the first number of time-domain units are the first number of continuous time-domain units.

3. The method of claim 1, wherein generating the first physical layer data comprises:
generating at least one data symbol based on a physical signal or channel;
for each of the at least one data symbol:
mapping the data symbol onto subcarrier with predetermined subcarrier index to obtain a frequency-domain signal;
generating, based on the frequency-domain signal, a first repetition physical layer data unit being on one time-domain unit, wherein the first repetition physical layer data unit includes a cyclic prefix and the first physical layer data unit with the first number of repetitions.

4. The method of claim 3, wherein mapping the data symbol onto the subcarriers with the predetermined subcarrier indexes comprises:
mapping the data symbol onto the subcarriers with even indexes at a subcarrier mapping spacing, wherein the subcarrier mapping spacing corresponds to the first number,
wherein subcarriers with odd indexes within the time-domain unit corresponding to each of the at least one data symbol are unavailable subcarriers,
wherein the subcarrier mapping spacing has a configurable value, or the subcarrier mapping spacing has a fixed value, or the subcarrier mapping spacing has a value of 2,
wherein the subcarrier mapping spacing is configured by at least one of a higher layer signaling, downlink control information, or media access control MAC control information,
wherein the subcarrier mapping spacing is configured for specific physical layer data, or for specific one or more transmissions of specific physical layer data, or for specific physical resources,
wherein the subcarrier mapping spacing is configured by configuring a configured subcarrier spacing for transmission of the physical channel or signal, and
wherein the length of the cyclic prefix is a length of a cyclic prefix corresponding to the configured subcarrier spacing.

5. The method of claim 1,
wherein the first number is an even number, or the first number is a power of 2,
wherein at least one of the first number, the second number and a total number is a configurable parameter, wherein the total number is a product of the first number and the second number,
wherein the physical channel or signal comprises at least one of a physical uplink shared channel PUSCH, a sounding reference signal SRS or a demodulation reference signal DMRS, and
wherein the second number is a value greater than or equal to 1.

6. The method of claim 2,
wherein the number of first physical layer data units among the at least one first physical layer data unit that are associated with the first number of continuous time-domain units is determined based at least in part on the number of continuously allocated time-domain units allocated to the physical channel or signal and the first number, and
wherein when the first physical layer data occupies a plurality of slots, the first physical layer data occupies time-domain units at the same position in the plurality of slots.

7. The method of claim 2, wherein when the physical channel or signal is a physical uplink shared channel PUSCH, the method further comprises:
determining position of time-domain unit of a demodulation reference signal DMRS based on at least one of indication of repetition type of the PUSCH, indication of time-domain position offset of the DMRS, or indication of time-domain position of the DMRS.

8. The method of claim 7, wherein determining the position of time-domain unit of the DMRS comprises:
obtaining the indication of time-domain position offset of the DMRS, determining the position of time-domain unit of the DMRS based on the obtained indication of time-domain position offset of the DMRS, wherein the indication of time-domain position offset of the DMRS is obtained by at least one of a higher layer signaling, downlink control information, and MAC control information.

9. A first node in a wireless communication system, comprising:
a transceiver; and
a controller configured to:
generate first physical layer data, wherein the first physical layer data includes first physical layer data unit with a first number of repetitions, generate based on the first physical layer data, second physical layer data, wherein the second physical layer data includes the first physical layer data with a second number of repetitions, and
transmit the second physical layer data.

10. The first node of claim 9, the controller further configured to:
generate at least one first physical layer data unit based on a physical signal or channel, and
generate, for each of all or part of the at least one first physical layer data unit, a first repetition physical layer data unit being on the first number of time-domain units, wherein each first repetition physical layer data unit includes a cyclic prefix and the first physical layer data unit with the first number of repetitions,
wherein the length of the cyclic prefix is a sum of lengths of respective cyclic prefixes of the first number of time-domain units, and wherein the first number of time-domain units are the first number of continuous time-domain units.

11. The method of claim 9, the controller further configured to:
generate at least one data symbol based on a physical signal or channel, for each of the at least one data symbol:
map the data symbol onto subcarrier with predetermined subcarrier index to obtain a frequency-domain signal,
generate, based on the frequency-domain signal, a first repetition physical layer data unit being on one time-domain unit, wherein the first repetition physical layer data unit includes a cyclic prefix and the first physical layer data unit with the first number of repetitions.

12. The method of claim 11, the controller further configured to: map the data symbol onto the subcarriers with even indexes at a subcarrier mapping spacing, wherein the subcarrier mapping spacing corresponds to the first number,
wherein subcarriers with odd indexes within the time-domain unit corresponding to each of the at least one data symbol are unavailable subcarriers,
wherein the subcarrier mapping spacing has a configurable value, or the subcarrier mapping spacing has a fixed value, or the subcarrier mapping spacing has a value of 2,
wherein the subcarrier mapping spacing is configured by at least one of a higher layer signaling, downlink control information, or media access control MAC control information,
wherein the subcarrier mapping spacing is configured for specific physical layer data, or for specific one or more transmissions of specific physical layer data, or for specific physical resources,
wherein the subcarrier mapping spacing is configured by configuring a configured subcarrier spacing for transmission of the physical channel or signal, and
wherein the length of the cyclic prefix is a length of a cyclic prefix corresponding to the configured subcarrier spacing.

13. The method of claim 9,
wherein the first number is an even number, or the first number is a power of 2,
wherein at least one of the first number, the second number and a total number is a configurable parameter, wherein the total number is a product of the first number and the second number,
wherein the physical channel or signal comprises at least one of a physical uplink shared channel PUSCH, a sounding reference signal SRS or a demodulation reference signal DMRS, and
wherein the second number is a value greater than or equal to 1.

14. The method of claim 10,
wherein the number of first physical layer data units among the at least one first physical layer data unit that are associated with the first number of continuous time-domain units is determined based at least in part on the number of continuously allocated time-domain units allocated to the physical channel or signal and the first number, and
wherein when the first physical layer data occupies a plurality of slots, the first physical layer data occupies time-domain units at the same position in the plurality of slots.

15. The method of claim 10, the controller further configured to:
determine position of time-domain unit of a demodulation reference signal DMRS based on at least one of indication of repetition type of the PUSCH, indication of time-domain position offset of the DMRS, or indication of time-domain position of the DMRS.
